(19) United States
(12) Patent Application Publication
(10) Pub. No.: US 2026/0006447 A1
(43) Pub. Date: Jan. 1, 2026

(54) AUTOMATIC CONFIGURATION OF INTER-NODE CARRIER AGGREGATION IN A CELLULAR NETWORK

(71) Applicant: TELEFONAKTIEBOLAGET LM ERICSSON (PUBL), Stockholm (SE)

(72) Inventors: Eugene Gomes, Plano, TX (US); Anup Kumar, Kolkata (IN)

(21) Appl. No.: 19/254,743

(22) Filed: Jun. 30, 2025

Related U.S. Application Data
(60) Provisional application No. 63/666,406, filed on Jul. 1, 2024.

(51) Int. Cl. H04W 16/10; H04W 36/00

(52) U.S. Cl. CPC H04W 16/10; H04W 36/00692

(57) ABSTRACT

A method implemented in a cellular network to automatically configure inter-node carrier aggregation between cells. The method includes identifying, for a source cell included in the cellular network, a set of one or more candidate target cells, determining one or more coverage overlap factors for the source cell and a first candidate target cell included in the set of one or more candidate target cells, determining whether carrier aggregation should be enabled between the source cell and the first candidate target cell based on the one or more coverage overlap factors, and in response to determining that carrier aggregation should be enabled between the source cell and the first candidate target cell, enabling carrier aggregation between the source cell and the first candidate target cell.

### CROSS-REFERENCE TO RELATED APPLICATIONS

This application claims the benefit of U.S. Provisional Application No. 63/666,406, filed Jul. 1, 2024, which is hereby incorporated by reference.

### TECHNICAL FIELD

Embodiments of the invention relate to the field of cellular networks, and more specifically, to automatically configuring inter-node carrier aggregation in a cellular network.

### BACKGROUND

Carrier aggregation is a cellular technology that enables the simultaneous transmission of data in multiple frequency bands or carriers to a single user equipment (UE). The use of carrier aggregation may improve capacity, enable more efficient utilization of a discontinuous spectrum, and provide an increase in downlink throughput and/or transmission speeds. When in carrier aggregation mode, a UE may be assigned one primary cell (or PCell) and one or more secondary cells (SCells). The primary cell is the cell in which the UE establishes a radio resource control (RRC) connection. The secondary cells may be assigned to the UE after the RRC connection has been successfully established in the primary cell. The primary cell may operate in a primary frequency and the secondary cells may operate in secondary frequencies that are different from the primary frequency. The primary cell and secondary cells may perform carrier aggregation with each other by simultaneously transmitting data to the UE. Carrier aggregation is described in Third Generation Partnership Project (3GPP) technical specifications (TS) such as 3GPP TS 36.331, 3GPP TS 36.321, 3GPP TS 36.213, and 3GPP TS 36.101.

The basic/standard carrier aggregation feature aggregates component carriers provided by a by a single node (e.g., eNodeB). Inter-eNodeB carrier aggregation (also referred to as IeNB CA) is a technology used in cellular networks (e.g., Long Term Evolution (LTE) and Fifth Generation (5G) cellular networks) to increase data throughput by aggregating component carriers spread across cells provided by different eNodeBs. With inter-eNodeB carrier aggregation, the set of cells considered for use as secondary cells to a primary cell is expanded to include cells provided by other eNodeBs. As a result, UEs may find a better set of cells with which to perform carrier aggregation, which in turn can lead to increased overall throughput. The use of inter-eNodeB carrier aggregation may increase network resource utilization and improve the overall user experience. Inter-eNodeB carrier aggregation may be particularly useful in environments where there is a need for high data throughput such as densely populated urban areas.

Configuring inter-eNodeB carrier aggregation in a cellular network requires identifying cells that should be allowed to perform carrier aggregation with each other and enabling carrier aggregation between the identified cells. Currently, a network operator has to manually identify which cells should be allowed to perform carrier aggregation with each other based on the network operator's own domain knowledge and expertise. That is, the network operator has to manually identify the cells that can serve as secondary cells for a primary cell. However, this process is time-consuming and prone to human judgement and error. The problem is further exacerbated because this process has to be performed periodically, as the network topology and/or characteristics can change over time.

### SUMMARY

An embodiment is a method implemented in a cellular network to automatically configure inter-node carrier aggregation between cells. The method includes identifying, for a source cell included in the cellular network, a set of one or more candidate target cells, determining one or more coverage overlap factors for the source cell and a first candidate target cell included in the set of one or more candidate target cells, determining whether carrier aggregation should be enabled between the source cell and the first candidate target cell based on the one or more coverage overlap factors, and in response to determining that carrier aggregation should be enabled between the source cell and the first candidate target cell, enabling carrier aggregation between the source cell and the first candidate target cell.

An embodiment is a non-transitory machine-readable medium storing instructions that, when executed by at least one processor, cause the at least one processor to perform operations for automatically configuring inter-node carrier aggregation between cells in a cellular network. The operations include identifying, for a source cell included in the cellular network, a set of one or more candidate target cells, determining one or more coverage overlap factors for the source cell and a first candidate target cell included in the set of one or more candidate target cells, determining whether carrier aggregation should be enabled between the source cell and the first candidate target cell based on the one or more coverage overlap factors, and in response to determining that carrier aggregation should be enabled between the source cell and the first candidate target cell, enabling carrier aggregation between the source cell and the first candidate target cell.

An embodiment is a computing device configured to automatically configure inter-node carrier aggregation between cells in a cellular network. The computing device includes at least one processor and a non-transitory machine-readable medium storing instructions that, when executed by at least one processor, cause the at least one processor to perform operations including identifying, for a source cell included in a cellular network, a set of one or more candidate target cells, determining one or more coverage overlap factors for the source cell and a first candidate target cell included in the set of one or more candidate target cells, determining whether carrier aggregation should be enabled between the source cell and the first candidate target cell based on the one or more coverage overlap factors, and in response to determining that carrier aggregation should be enabled between the source cell and the first candidate target cell, enabling carrier aggregation between the source cell and the first candidate target cell.

### BRIEF DESCRIPTION OF THE DRAWINGS

The invention may best be understood by referring to the following description and accompanying drawings that are used to illustrate particular embodiments of the invention. In the drawings:

FIG. 1 is a diagram showing a cellular network that includes a carrier aggregation configuration component for automatically configuring carrier aggregation in the cellular network, according to some embodiments.

FIG. 2 is a diagram showing an azimuth correlation, according to some embodiments.

FIG. 3 is a flow diagram showing a method for automatically configuring carrier aggregation in a cellular network, according to some embodiments.

FIG. 4 is a diagram showing how the carrier aggregation configuration technique can be implemented within an Open Radio Access Network (O-RAN) architecture, according to some embodiments.

FIG. 5 is a flow diagram of a method for automatically configuring carrier aggregation in a cellular network, according to some embodiments.

FIG. 6 is a diagram showing an example communication system, according to some embodiments.

FIG. 7 is a diagram showing a UE 700, according to some embodiments.

FIG. 8 is a diagram showing a network node 800, according to some embodiments.

FIG. 9 is a block diagram showing a virtualization environment 900 in which functionality described herein can be virtualized, according to some embodiments.

### DETAILED DESCRIPTION

As mentioned above, currently, a network operator of a cellular network has to manually identify which cells should be allowed to perform carrier aggregation with each other based on the network operator's own domain knowledge and expertise. However, this process is time consuming and prone to human judgement and error.

The present disclosure introduces a carrier aggregation configuration technique that can automatically identify cells that are well-suited for performing carrier aggregation with each other based on coverage overlap and enable carrier aggregation between those cells. According to some embodiments, the carrier aggregation configuration technique may identify a source cell included in the cellular network and a set of one or more candidate target cells. For each candidate target cell included in the set of one or more candidate target cells, the carrier aggregation configuration technique may determine one or more coverage overlap factors for the source cell and the target candidate cell. A coverage overlap factor for a source cell and a candidate target cell may be a value indicative/suggestive of an amount of coverage overlap between the source cell and the candidate target cell. In an embodiment, the coverage overlap factors include a handover factor, a distance factor, and an azimuth correlation factor. The handover factor for a source cell and a candidate target cell may be a value indicative of the number of handovers between the source cell and the candidate target cell over a period of time compared to the number of all outgoing/incoming handovers from/to the source cell over the same period of time. The distance factor for a source cell and a candidate target cell may be a value indicative of the geographical distance between the source cell and the candidate target cell. The azimuth correlation factor for a source cell and a candidate target cell may be a value indicative of how closely the source cell's main transmission direction (e.g., the direction of the source node antenna's main lobe) aligns with the direction going from the source cell to the candidate target cell. The carrier aggregation configuration technique may determine whether to enable carrier aggregation for the source cell and a candidate target cell based on the coverage overlap factors for the source cell and the candidate target cell. For example, the carrier aggregation configuration technique may determine that carrier aggregation should be enabled for the source cell and the particular candidate target cell if all of the coverage overlap factors for the source cell and the particular candidate target cell are deemed to be acceptable. As another example, the carrier aggregation configuration technique may determine that carrier aggregation should be enabled for the source cell and a candidate target cell if a majority of the coverage overlap factors for the source cell and the candidate target cell (e.g., two out of three) are deemed to be acceptable. As another example, the carrier aggregation configuration technique may determine that carrier aggregation should be enabled for the source cell and a candidate target cell if a value that is derived based on a combination of the coverage overlap factors (e.g., a weighted sum) is deemed to be acceptable. If the carrier aggregation configuration technique determines that carrier aggregation should be enabled between the source cell and a particular candidate target cell, it may enable carrier aggregation between the source cell and the particular candidate target cell (if carrier aggregation is not already enabled). Enabling carrier aggregation between the source cell and the particular candidate target cell may involve adding the particular candidate target cell to a list of possible secondary cells for the source cell (so that the cellular network may assign the particular candidate target cell to be a secondary cell for a UE when the UE is connected to the source cell as its primary cell). If the carrier aggregation configuration technique determines that carrier aggregation should not be enabled for the source cell and a particular candidate target cell, it may disable carrier aggregation between the source cell and the particular candidate target cell (if carrier aggregation is currently enabled). Disabling carrier aggregation between the source cell and the particular candidate target cell may involve removing the particular candidate target cell from the list of possible secondary cells for the source cell (so that the cellular network does not assign the particular candidate target cell to be a secondary cell for a UE when the UE is connected to the source cell as its primary cell). The carrier aggregation configuration technique may continuously/periodically make carrier aggregation enablement/disablement decisions for the cellular network based on monitoring updated network information.

The carrier aggregation configuration technique may thus continuously monitor the cellular network for pairs of cells that are well-suited for performing carrier aggregation with each other based on coverage overlap and automatically enable carrier aggregation between those pairs of cells. The carrier aggregation configuration technique may also automatically disable carrier aggregation between pairs of cells that are no longer deemed to be suitable for performing carrier aggregation with each other (e.g., due to a change in network topology/characteristics).

In a specific use case, the carrier aggregation configuration technique may monitor the cellular network for macro cell and small cell pairs that are well-suited for performing carrier aggregation with each other (based on coverage overlap) and automatically enable carrier aggregation between those macro cell and small cell pairs. Small cells are typically designed to have lower capacity compared to macro cells. By automatically enabling carrier aggregation between small cells and macro cells, the carrier aggregation configuration technique may be able to reduce the load of the small cells and improve performance in the small cells. Also, if a macro cell and small cell pair is no longer deemed to be suitable for performing carrier aggregation with each other (e.g., due to changes in the network topology resulting in reduced coverage overlap), the carrier aggregation configuration technique may automatically disable carrier aggregation between the macro cell and small cell pair. This may prevent the macro cell and small cell pair from performing carrier aggregation with each other when the cells are deemed to no longer have good coverage overlap.

A technological advantage provided by the carrier aggregation configuration technique disclosed herein is that it allows carrier aggregation (e.g., inter-eNodeB carrier aggregation) to be configured and managed in a cellular network with minimal user/human intervention. Carrier aggregation can be configured more quickly and efficiently compared to existing manual approaches. Also, by taking into consideration various coverage overlap factors introduced herein such as a handover factor, a distance factor, and/or an azimuth correlation factor, the carrier aggregation configuration technique disclosed herein can more accurately identify pairs of cells that are well-suited for performing carrier aggregation with each other. Enabling carrier aggregation between cells that have good coverage overlap may result in higher throughput, higher bandwidth, higher spectral efficiency, and/or more efficient usage of network resources when performing carrier aggregation. Also, by automatically disabling carrier aggregation between pairs of cells that are deemed to no longer have good coverage overlap, the carrier aggregation configuration technique disclosed herein may prevent network performance degradation.

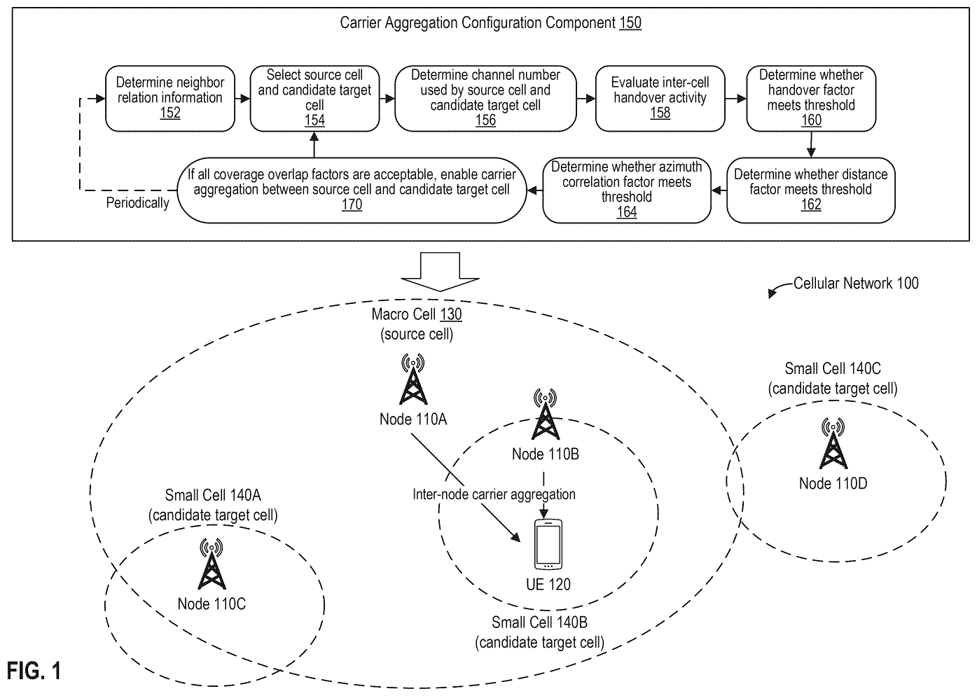

FIG. 1 is a diagram showing a cellular network that includes a carrier aggregation configuration component for automatically configuring carrier aggregation in the cellular network, according to some embodiments.

As shown in the diagram, the cellular network 100 includes node 110A, node 110B, node 110C, and node 110D (one or more of which may be generally referred to as nodes 110). Each node 110 may be a radio node (e.g., an eNodeB or gNodeB) that provides one or more cells. For example, node 110A may provide macro cell 130, node 110B may provide small cell 140B, node 110C may provide small cell 140A, and node 110D may provide small cell 140C (one or more of the small cells may be generally referred to as small cells 140). For simplicity of explanation, the diagram shows each node 110 as providing a single cell. It should be appreciated, however, that a given node 110 can provide more than one cell. As shown in the diagram, the coverage areas of the cells in the cellular network 100 may entirely or partially overlap. In an embodiment, the cellular network 100 is a Long Term Evolution (LTE) mobile network, 5G mobile network, or the like.

Also, as shown in the diagram, the cellular network 100 may include a UE 120. The UE 120 may be any type of network device that is able to wirelessly access the cellular network 100 via one or more nodes 110 such as a smartphone, a laptop, a desktop computer, Internet of Things (IoT) device, or the like. The UE 120 may be located within the coverage area of one or more cells. In the example shown in the diagram, the UE 120 is located within the coverage areas of macro cell 130 and small cell 140B, and thus may be able to take advantage of an inter-node carrier aggregation feature of the cellular network 100 if carrier aggregation is enabled between the macro cell 130 and small cell 140B. For simplicity of explanation, the diagram shows the cellular network as including a single UE 120. It should be appreciated, however, that in practice the cellular network 100 will likely include additional UEs.

As mentioned earlier herein, configuring carrier aggregation in a cellular network 100 requires identifying cells that should be allowed to perform carrier aggregation with each other and enabling carrier aggregation between the identified cells. For this purpose, as shown in the diagram, the cellular network 100 may include a carrier aggregation configuration component 150 that can identify pairs of cells that are well-suited for performing carrier aggregation with each other and automatically enable carrier aggregation between the identified cells. As will be described in additional detail herein, the carrier aggregation configuration component 150 may determine which pairs of cells are well-suited for performing carrier aggregation with each other based on coverage overlap, which may be measured/estimated based on one or more coverage overlap factors such as a handover factor, a distance factor, and an azimuth correlation factor. In an embodiment, the carrier aggregation configuration component 150 may perform operations 152-170 shown in the diagram, which are further described herein below.

As shown in the diagram, at operation 152, the carrier aggregation configuration component 150 may collect neighbor relation information of the cellular network 100. The neighbor relation information may include information regarding which cells in the cellular network 100 are neighbors with each other. Cells may be considered to be neighbors with each other based on geographical proximity (e.g., cells that are within a predefined distance from each other may be considered to be neighbors) or location (e.g., cells that are within the same geographic, political, administrative, or communication domain may be considered to be neighbors). In the example shown in the diagram, the carrier aggregation configuration component 150 may determine that small cell 140A, small cell 140B, and small cell 140C are neighbors of macro cell 130. For sake of simplicity, the diagram does not show non-neighbor cells of macro cell 130.

At operation 154, the carrier aggregation configuration component 150 may select a source cell and a candidate target cell for evaluation. The source cell may be a cell that can serve as a primary cell for UEs (e.g., UE 120) in the cellular network 100 and the candidate target cells may be cells that are candidates to serve as secondary cells to the primary cell. The candidate target cell may be one of the (inter-node) neighboring cells of the source cell (as identified by the neighbor relations information). In the example shown in the diagram, the carrier aggregation configuration component 150 may select the macro cell 130 to be the source cell and select one of the small cells 140 to be the candidate target cell.

The carrier aggregation configuration component 150 may determine whether a source cell and a candidate target cell are suitable for performing carrier aggregation with each other based on one or more coverage overlap factors. A coverage overlap factor for a source cell and a candidate target cell may be a value indicative/suggestive of an amount of coverage overlap between the source cell and the candidate target cell. In an embodiment, the coverage overlap factors include a handover factor, a distance factor, and an azimuth correlation factor, which are further described in additional detail herein below.

At operation 156, the carrier aggregation configuration component 150 may determine the channel number used by the source cell and the candidate target cell. In an embodiment, the channel number may be an Evolved Universal Terrestrial Radio Access absolute radio-frequency channel number (EARFCN) (e.g., downlink EARFCN). Carrier aggregation may not be possible between cells using the same channel number so if the source cell and the candidate target cell use the same channel number (or otherwise use the same central frequency), then that cell pair may be excluded from further evaluation, and the carrier aggregation configuration component 150 may immediately conclude that carrier aggregation should not be enabled between the source cell and the candidate target cell.

At operation 158, the carrier aggregation configuration component 150 may evaluate inter-cell handover activity and interactions. Operation 158 may involve gathering and/or determining statistics regarding handovers between the source cell and other cells in the cellular network 100 (including the candidate target cell). The statistics may be used for calculating a handover factor, as described in additional detail below.

At operation 160, the carrier aggregation configuration component 150 may calculate a handover factor for the source cell and the candidate target cell and determine whether the handover factor meets a threshold.

The handover factor for a source cell and a candidate target cell may be a value indicative of the number of handovers between the source cell and the candidate target cell over a period of time compared to the number of handovers between the source cell and all relevant candidate target cells over the same period of time. The handover numbers used as part of this calculation may be obtained from the information/statistics gathered from operation 158.

In an embodiment, the handover factor is determined according to the equation below:

$$Handover Factor = \frac{number of handovers between source cell \& target cell}{number of handovers between source cell and all target cells} \qquad Equation 1$$

That is, the handover factor is equal to the number of handovers between the source cell and the candidate target cell (over a period of time) divided by the number of handovers between the source cell and all candidate target cells (over the same period of time). The handover numbers in Equation 1 may be obtained from the information/statistics gathered from operation 158. In this example, a higher handover factor may be indicative of larger coverage overlap between the source cell and the candidate target cell, and the handover factor may be deemed acceptable if it is higher than or equal to a predefined handover threshold. In an embodiment, when calculating this metric, only inter-node cells that use a central frequency that is different from the source cell's central frequency are considered (e.g., when calculating the denominator of Equation 1).

The handover factor may be determined based on isolating contextually relevant handover information/statistics. When analyzing inter-frequency handover performance, including intra-frequency handovers in the comparison may lead to skewed conclusions. Thus, in an embodiment, only inter-frequency handovers are considered when determining the handover factor (e.g., only inter-node cells that use a central frequency that is different from the source cell's central frequency are considered in the denominator of Equation 1, as mentioned earlier). Also, comparing handover rates between macro cells and small cells should not involve macro-to-macro cell handovers, as it may distort the interaction dynamics. Thus, in an embodiment, only handovers between particular types of cells (e.g., macro-to-small cell and/or small-to-macro cell handovers) are considered when determining the handover factor. In an embodiment, the number of handovers between the source cell and a candidate target cell has to exceed a threshold number (over a certain period of time) for the candidate target cell to be considered for performing carrier aggregation with the source cell.

At operation 162, the carrier aggregation configuration component 150 may calculate a distance factor for the source cell and the candidate target cell and determine whether the distance factor meets a threshold.

The distance factor for a source cell and a candidate target cell may be a value indicative of the geographical distance between the source cell and the candidate target cell compared to the average geographical distance (or other statistical measure such as the median) between the source node (e.g., the radio node providing the source cell) and neighboring nodes (e.g., the radio nodes providing the candidate target cells). In an embodiment, the geographical distance between cells may be the geographical distance between the radio nodes that provide those cells.

In an embodiment, the distance factor is determined according to the equation below:

$$Distance Factor = \frac{distance between source cell and target cell}{average internode distance} \qquad Equation 2$$

That is, the distance factor is equal to the geographical distance between the source cell and the candidate target cell (e.g., the geographical distance between the radio nodes providing those cells) divided by the average of the geographical distances between the source node (e.g., the radio node providing the source cell) and all neighboring nodes (e.g., the radio nodes providing the candidate target cells). In this example, a lower distance factor may be indicative of larger coverage overlap between the source cell and the candidate target cell, and the distance factor may be deemed acceptable if it is lower than or equal to a predefined distance threshold.

At operation 164, the carrier aggregation configuration component 150 may calculate an azimuth correlation factor for the source cell and the candidate target cell and determine whether the azimuth correlation factor meets a threshold.

The azimuth correlation factor for a source cell and a candidate target cell may be a value indicative of how closely the source cell's main transmission direction (e.g., the direction of the source node antenna's main lobe) aligns with the direction going from the source cell to the candidate target cell.

In an embodiment, the azimuth correlation factor is determined according to the equation below:

$$Azimuth Correlation = \vert source cell azimuth - source cell to target cell azimuth \vert \qquad Equation 3$$

That is, the azimuth correlation factor is equal to the absolute value of the difference between the azimuth of the source cell's main transmission direction and the azimuth of the direction going from the source cell to the candidate target cell. In this example, a lower azimuth correlation factor may be indicative of larger coverage overlap between the source cell and the candidate target cell, and the azimuth correlation factor may be deemed acceptable if it is lower than or equal to a predefined azimuth correlation threshold.

In the above equations (Equation 1, Equation 2, and Equation 3), the source cell may refer to a primary cell for which suitable secondary cells are being identified, and the target cell (or candidate target cell) may refer to a cell that is being evaluated for its suitability for performing carrier aggregation with the primary cell. In some embodiments, the source cell is a macro cell and the candidate target cells are small cells that are neighbors of the source cell. In some embodiments, the source cell is a small cell and the candidate target cells are macro cells that are neighbors of the source cell.

At operation 170, the carrier aggregation configuration component 150 may determine whether all of the coverage overlap factors for the source node and the candidate target cell are acceptable, and if so, enable carrier aggregation between the source cell and the candidate target cell. The carrier aggregation configuration component 150 may enable carrier aggregation between the source cell and the candidate target cell by adding the candidate target cell to a list of possible secondary cells for the source (primary) cell (so that the candidate target cell is allowed to be used for performing carrier aggregation with the source cell).

The carrier aggregation configuration component 150 may repeat operations 154-170 for other source cell and candidate target cell pairs. It is noted that carrier aggregation can be enabled between the source cell and multiple candidate target cells. A given UE can simultaneously connect to one primary cell and multiple secondary cells (with all of these cells performing carrier aggregation with each other). Also, the carrier aggregation configuration component 150 may periodically repeat the entire process (e.g., starting at operation 152) to make carrier aggregation enable decisions using updated network information (e.g., in case there was a change in network topology).

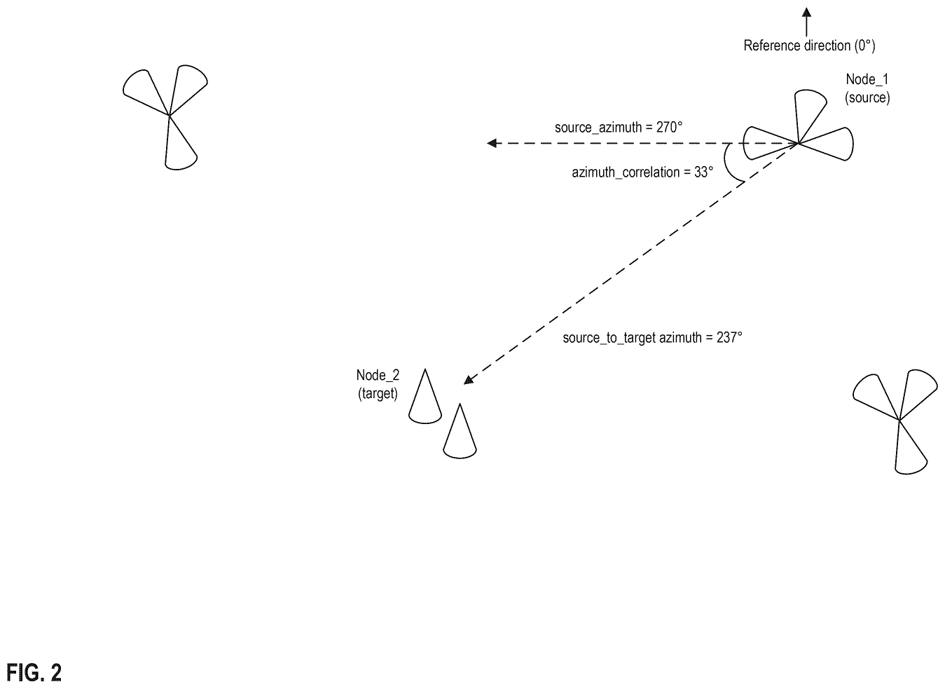

FIG. 2 is a diagram showing an azimuth correlation, according to some embodiments.

As diagram shows a cellular network that includes a first node (“Node_1”) and a second node (“Node_2”) among other nodes. In this example, Node_1 may provide a source cell (so Node_1 is a source node) and Node_2 may provide a candidate target cell. The source cell provided by Node_1 may have an azimuth of 270 degrees (source_azimuth=) 270° with respect to a reference direction (0 degrees). The direction going from the source cell to the candidate target cell (e.g., the direction of an imaginary line connecting Node_1 to Node_2) may have an azimuth of 237 degrees (source_to_target_azimuth=) 237° with respect to the reference direction. Thus, the azimuth correlation for the source cell (cell provided by Node_1) and the candidate target cell (cell provided by Node_2) in this example may be 33 degrees (azimuth_correlation=270°-237°=) 33°.

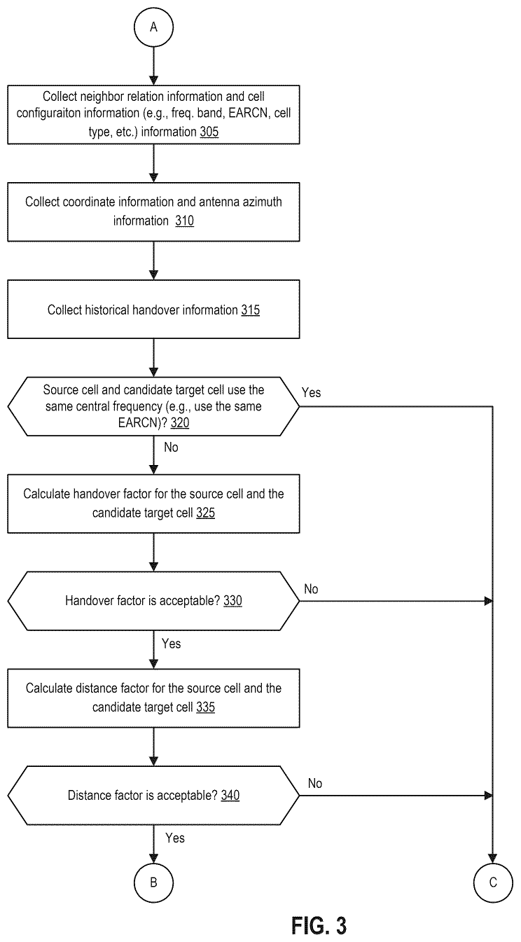

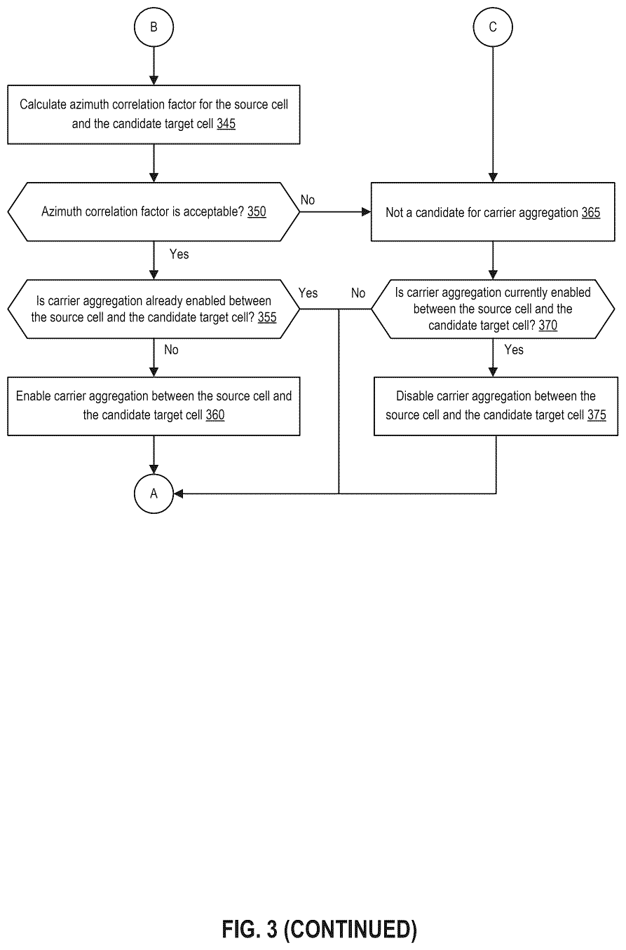

FIG. 3 is a flow diagram showing a method for automatically configuring carrier aggregation in a cellular network, according to some embodiments. The method may be implemented by a carrier aggregation configuration component 150 in the cellular network 100.

At operation 305, the carrier aggregation configuration component may collect neighbor relation information and cell configuration information. The neighbor relation information may include information regarding which cells in the cellular network are neighbors with each other. The cell configuration information may include information regarding the configurations of cells in the cellular network such as the cell type (e.g., macro cell, small cell, etc.), the frequency band in which a cell operates, the central frequency or channel number used by a cell, and/or other configuration information related to the cell and/or the node that provides the cell.

At operation 310, the carrier aggregation configuration component may collect coordinate information and antenna azimuth information. The coordinate information may include the geolocation coordinates (e.g., latitude and longitude) of the cells (e.g., the geolocation coordinates of the nodes that provide the cells). The antenna azimuth information may include the azimuths of the cells (e.g., the main transmission direction azimuth).

At operation 315, the carrier aggregation configuration component may collect historical handover information. The historical handover information may include counts/statistics of the number of handovers that occurred between cells in the cellular network during a period of time.

At operation 320, the carrier aggregation configuration component may determine whether a source cell and a candidate target cell use the same central frequency (e.g., use the same EARFCN or analogous channel number). If the source cell and the candidate target cell use the same central frequency, then the flow may move to operation 365 to start a carrier aggregation disabling sequence since carrier aggregation cannot be performed between cells that use the same central frequency. Otherwise, if the source cell and the candidate target cell do not use the same central frequency, then the flow may move to operation 325.

At operation 325, the carrier aggregation configuration component may calculate a handover factor for the source cell and the candidate target cell (e.g., using Equation 1).

At operation 330, the carrier aggregation configuration component may determine whether the handover factor is acceptable. For example, the handover factor may be acceptable if it meets a predefined threshold (e.g., it is higher than a predefined handover threshold). If the handover factor is acceptable, then the flow may move to operation 335. Otherwise, if the handover factor is not acceptable, then the flow may move to operation 325 to start the carrier aggregation disabling sequence.

At operation 335, the carrier aggregation configuration component may calculate a distance factor for the source cell and the candidate target cell (e.g., using Equation 2).

At operation 340, the carrier aggregation configuration component may determine whether the distance factor is acceptable. For example, the distance factor may be acceptable if it meets a predefined threshold (e.g., it is lower than a predefined distance threshold). If the distance factor is acceptable, then the flow may move to operation 345. Otherwise, if the distance factor is not acceptable, then the flow may move to operation 325 to start the carrier aggregation disabling sequence.

At operation 345, the carrier aggregation configuration component may calculate an azimuth correlation factor for the source cell and the candidate target cell (e.g., using Equation 3).

At operation 350, the carrier aggregation configuration component may determine whether the azimuth correlation factor is acceptable. For example, the azimuth correlation factor may be acceptable if it meets a predefined threshold (e.g., it is lower than a predefined azimuth correlation threshold). If the azimuth correlation factor is acceptable, then the flow may move to operation 355. Otherwise, if the azimuth correlation factor is not acceptable, then the flow may move to operation 355 to start the carrier aggregation disabling sequence.

If the flow reaches operation 355, this means that all of the coverage overlap factors for the source cell and the candidate target cell being evaluated (i.e., the handover factor, the distance factor, and the azimuth correlation factor) have been found to be acceptable, meaning that the source cell and the candidate target cell are deemed to have enough coverage overlap for purposes of performing carrier aggregation with each other.

At operation 355, the carrier aggregation configuration component may determine whether carrier aggregation is already enabled between the source cell and the candidate target cell. If carrier aggregation is already enabled between the source cell and the candidate target cell, then the flow may end, move to operation 320 to start a new evaluation (for a different candidate target cell), or move to operation 305 to start a new iteration (e.g., with updated network information). Otherwise, if carrier aggregation is not already enabled between the source cell and the candidate target cell, then the flow may move to operation 360.

At operation 360, the carrier aggregation configuration component may enable carrier aggregation between the source cell and the candidate target cell. In an embodiment, enabling carrier aggregation between the source cell and the candidate target cell involves adding the candidate target cell to a list of possible secondary cells for the source (primary) cell (so that the candidate target cell can be used for performing carrier aggregation with the source cell).

Operations 365-375 may provide a carrier aggregation disabling sequence for disabling carrier aggregation between the source cell and the candidate target cell when the source cell and the candidate target cell pair are deemed to not have enough coverage overlap for purposes of performing carrier aggregation with each other (e.g., when one or more of the coverage overlap factors are determined not to be acceptable).

At operation 365, the carrier aggregation configuration component may determine that the source cell and the candidate target cell pair is not a candidate for carrier aggregation (because the cell pair does not have enough coverage overlap). At operation 370, the carrier aggregation configuration component may determine whether carrier aggregation is currently enabled between the source cell and the candidate target cell. If carrier aggregation is currently enabled between the source cell and the candidate target cell, then the flow may move to operation 375. At operation 375, the carrier aggregation configuration component may disable carrier aggregation between the source cell and the candidate target cell. In an embodiment, disabling carrier aggregation between the source cell and the candidate target cell involves removing the candidate target cell from a list of possible secondary cells for the source (primary) cell (so that the candidate target cell can no longer be used for performing carrier aggregation with the source cell). Returning to operation 370, if carrier aggregation is not currently enabled between the source cell and the candidate target cell, the flow may end, move to operation 320 to start a new evaluation (for a different candidate target cell), or move to operation 305 to start a new iteration (e.g., with updated network information). Thus, the carrier aggregation disabling sequence may disable carrier aggregation between the source cell and the candidate target cell if it is determined that the source cell and the candidate target cell do not have enough coverage overlap and carrier aggregation is currently enabled between the source cell and the candidate target cell.

One or more of the operations shown in the diagram may be repeated for each source cell and candidate target cell pair to automatically enable/disable carrier aggregation between the cell pair.

The coverage overlap between cells in a live cellular network can change over time (e.g., due to changes in network topology or configuration). Thus, the operations of the flow diagram may be repeated on a periodic basis (e.g., weekly or daily) to update the carrier aggregation enablement/disablement decisions using up-to-date network information.

While the flow diagram shows an example where all three coverage overlap factors (handover factor, distance factor, and azimuth correlation factor) need to be acceptable for carrier aggregation to be enabled between cells, other embodiments may use different criteria. For example, carrier aggregation may be enabled when a majority of the coverage overlap factors (e.g., 3 out of 5) are deemed acceptable or when a value that is derived based on a combination of the coverage overlap factors (e.g., a weighted sum) is deemed to be acceptable.

Although the operations are shown and described in a particular order, in other embodiments, the operations can be performed in a different order. Additionally or alternatively, various operations could be performed at the same time as other operations. For example, the calculating and evaluating of the different coverage overlap factors (e.g., the handover factor (operations 325 and 330), the distance factor (operations 335 and 340), and the azimuth correlation factor (e.g., operations 345 and 350)) could be performed in a different order. As another example, two or more of the calculating and evaluating the distance factor, handover factor, and azimuth correlation factor could be performed in parallel.

Furthermore, in some embodiments, various operations could be combined or omitted. For example, in some embodiments, only candidate target cells for which carrier aggregation has been enabled are checked to determine whether carrier aggregation should be disabled for those candidate target cells. In such cases, operation 370 (checking if carrier aggregation is currently enabled) may be omitted.

In an embodiment, an inclusion list can be provided (e.g., by the network operator) that specifies which cells/nodes in the cellular network should be considered for automatic carrier aggregation configuration. The carrier aggregation configuration component may read this list and only apply the carrier aggregation configuration technique disclosed herein to the cells/nodes included in the inclusion list. This may give the network operator or communication service provider (CSP) more control/flexibility with regard to which cells/nodes are allowed to be automatically identified for enabling carrier aggregation.

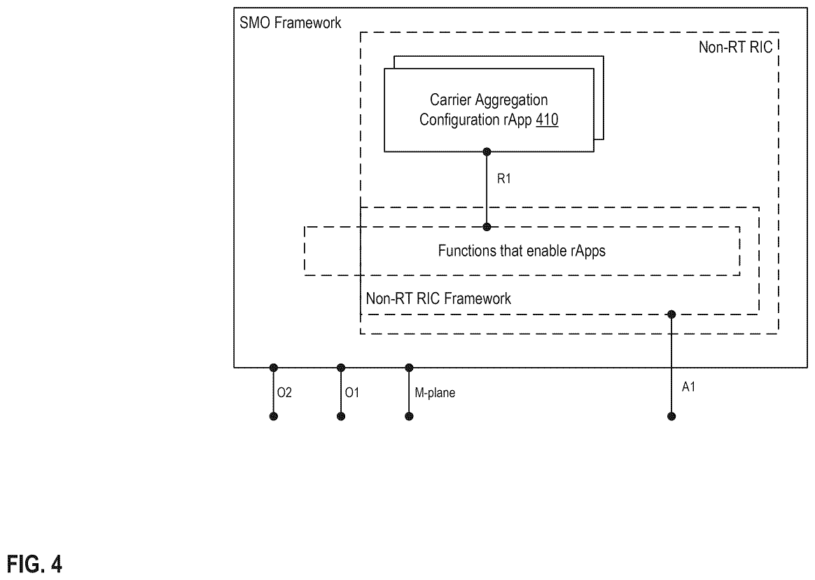

FIG. 4 is a diagram showing how the carrier aggregation configuration technique can be implemented within an Open RAN architecture, according to some embodiments.

In an embodiment, the carrier aggregation configuration technique can be implemented within an O-RAN architecture. An O-RAN architecture may include a service management and orchestration (SMO) framework that is responsible for managing and orchestrating various RAN functionality. The SMO framework may provide openness and offer an automation platform that is cloud native, whereas per O-RAN principles, interfaces are available that enable connectivity and inter-operation between SMO, RAN functions, and other applications. Hierarchically, the SMO framework may be a component of the operational support system (OSS). Within the zero-touch service management European Telecommunication Standards Institute (ETSI-ZSM), it may be viewed as a RAN domain controller. The SMO framework may include a non-real-time RAN intelligent controller (non-RT RIC). The Non-RT RIC may provide the ability to gather data from various sources both from the radio and external sources, as well as to host various rApps. The SMO framework may interface with other components of the O-RAN architecture (e.g., an O-cloud and RAN network functions) over various interfaces such as O2, O1, M-plane, and A1 interfaces. The O2 interface may be an SMO cloud-native deployment interface. The O1 and M-plane interfaces may be SMO FCAPS (fault, configuration, accounting, performance and security) interfaces to the RAN. The A1 interface may be a non-real-time RAN intelligent controller (non-RT RIC) to near-real-time RIC interface.

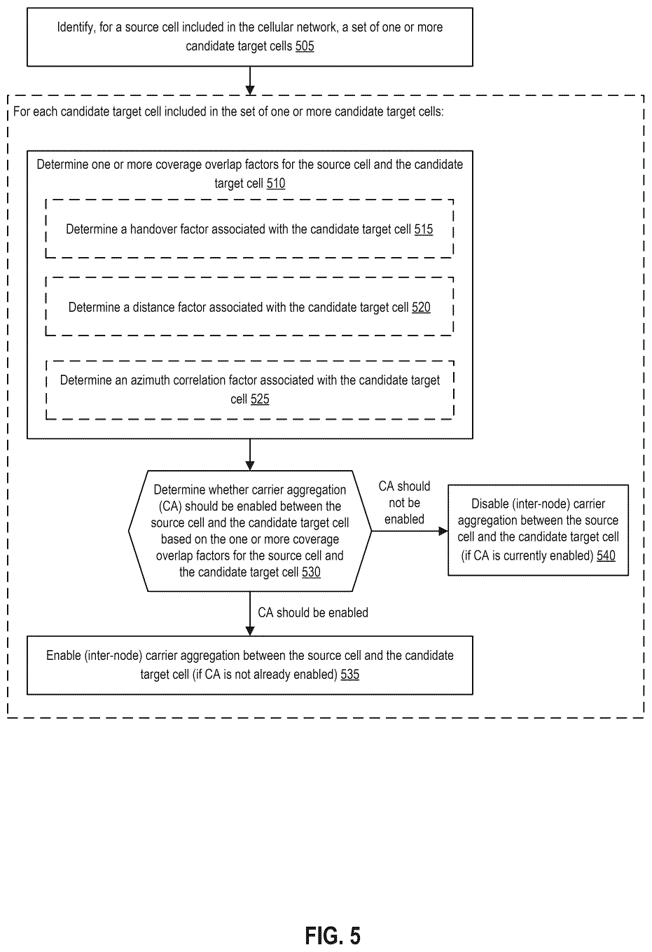

As shown in the diagram, a carrier aggregation configuration rApp 410 may run within the non-RT RIC. The carrier aggregation configuration rApp 410 may be configured to provide one or more of the functionalities described herein for automatically enabling/disabling carrier aggregation in a cellular network. For example, the carrier aggregation configuration rApp 410 may be configured to implement one or more of the operations of the flow diagrams shown in FIG. 3 and FIG. 5. In an embodiment, the carrier aggregation configuration technique is implemented in a node/RAN.

The carrier aggregation configuration technique disclosed herein may provide one or more technical advantages over existing carrier aggregation configuration approaches. An advantage provided by the carrier aggregation configuration technique disclosed herein is that it allows carrier aggregation (e.g., inter-eNodeB carrier aggregation) to be configured and managed in a cellular network with minimal user/human intervention. This allows carrier aggregation to be configured more quickly and efficiently compared to existing manual approaches. By taking into consideration various coverage overlap factors introduced herein such as the handover factor, the distance factor, and/or the azimuth correlation factor, the carrier aggregation configuration technique disclosed herein can more accurately identify pairs of cells that have good coverage overlap and thus are well-suited for performing carrier aggregation with each other. Enabling carrier aggregation between cells that have good coverage overlap may result in higher throughput, higher bandwidth, higher spectral efficiency, and/or more efficient usage of network resources when performing carrier aggregation. Also, by automatically disabling carrier aggregation between pairs of cells that are deemed to no longer have good coverage overlap (e.g., due to a network topology change), the carrier aggregation configuration technique disclosed herein may prevent network performance degradation (by preventing carrier aggregation from being performed between cells that do not have good coverage overlap).

The basic/standard carrier aggregation feature can be enhanced using dynamic secondary cell selection and automatic secondary cell management features. However, these features do not distinguish between the different cell types (e.g., macro cell and small cell), meaning that all cell types are treated the same. In some cases, a network operator or CSP may wish to enable carrier aggregation between specific cell types (e.g., between a macro cell and a small cell), but this type of special treatment based on cell type is not available with dynamic secondary cell selection and automatic secondary cell management features. For example, the existing automatic secondary cell management feature works on hit-rate and cannot detect/select only small cells as secondary cells. Also, the existing dynamic secondary cell selection and automatic secondary cell management features do not have a comprehensive mechanism to measure coverage overlap based on a distance factor, a handover factor, and an azimuth correlation factor.

FIG. 5 is a flow diagram of a method for automatically configuring carrier aggregation in a cellular network, according to some embodiments. The method may be performed by a computing device (e.g., a computing device implementing the carrier aggregation configuration component 150 or carrier aggregation configuration rAPP 410).

At operation 505, the computing device identifies, for a source cell included in the cellular network, a set of one or more candidate target cells. The one or more candidate target cells may be cells provided by nodes other than the node that provides the source cell. In an embodiment, the source cell is a macro cell and the candidate target cells included in the set of one or more candidate target cells are small cells (or vice versa). In an embodiment, identifying the set of one or more candidate target cells comprises identifying one or more cells that are neighbors of the source cell.

The computing device may perform one or more of operations 510-540 for each candidate target cell included in the set of one or more candidate target cells.

At operation 510, the computing device determines one or more coverage overlap factors for the source cell and the candidate target cell. In an embodiment, operation 510 involves one or more of operations 515-525. At operation 515, the computing device determines a handover factor associated with the candidate target cell. In an embodiment, the handover factor associated with the first candidate target cell is determined based on a number of handovers between the source cell and the first candidate target cell over a period of time and a number of handovers between the source cell and candidate target cells included in the set of one or more candidate target cells over the period of time. At operation 520, the computing device determines a distance factor associated with the candidate target cell. In an embodiment, the distance factor associated with the first candidate target cell is determined based on a geographical distance between the source cell and the first candidate target cell and an average (or other statistical measure) of geographical distances between a source node providing the source cell and neighboring nodes of the source node (e.g., nodes providing the candidate target cells included in the set of one or more candidate target cells). At operation 525, the computing device determines an azimuth correlation factor associated with the candidate target cell. In an embodiment, the azimuth correlation factor associated with the first candidate target cell is determined based on an azimuth associated with a main transmission direction of the source cell (with respect to a reference direction (e.g., true north)) and an azimuth of a direction going from the source cell to the candidate target cell (with respect to the reference direction).

At operation 530, the computing device determines whether carrier aggregation should be enabled between the source cell and the candidate target cell based on the one or more coverage overlap factors for the source cell and the candidate target cell. In an embodiment, determining whether carrier aggregation should be enabled between the source cell and the candidate target cell comprises determining whether the handover factor meets a threshold value, determining whether the distance factor meets a threshold value, and/or determining whether the azimuth correlation factor meets a threshold value.

If it is determined at operation 530 that carrier aggregation should be enabled, the flow may move to operation 535. At operation 535, the computing device enables (inter-node) carrier aggregation between the source cell and the candidate target cell. In an embodiment, enabling carrier aggregation between the source cell and the candidate target cell comprises adding the candidate target cell to a list of possible secondary cells for the source cell. In an embodiment, before enabling carrier aggregation between the source cell and the candidate target cell, the computing device determines whether carrier aggregation is already enabled between the source cell and the candidate target cell, wherein the enabling of carrier aggregation between the source cell and the candidate target cell is further in response to determining that carrier aggregation is not already enabled between the source cell and the candidate target cell.

If it is determined at operation 530 that carrier aggregation should not be enabled, the flow may move to operation 540. At operation 540, the computing device disables (inter-node) carrier aggregation between the source cell and the candidate target cell (if carrier aggregation is currently enabled between those cells).

In an embodiment, the computing device determines second one or more coverage overlap factors for the source cell and a second candidate target cell included in the set of one or more candidate target cells, determines whether carrier aggregation should be enabled between the source cell and the second candidate target cell based on the second one or more coverage overlap factors, and in response to determining that carrier aggregation should be enabled between the source cell and the second candidate target cell, enables carrier aggregation between the source cell and the second candidate target cell (if not already enabled). In an embodiment, the computing device assigns the source cell to be a primary cell for a UE in the cellular network and assigns the candidate target cell and the second candidate target cell to be secondary cells for the UE.

In an embodiment, after enabling carrier aggregation between the source cell and the candidate target cell, the computing device determines updated one or more coverage overlap factors for the source cell and the candidate target cell, determines whether carrier aggregation should be enabled between the source cell and the candidate target cell based on the updated one or more coverage overlap factors, and in response to determining, based on the updated one or more coverage overlap factors, that carrier aggregation should not be enabled between the source cell and the candidate target cell, disables carrier aggregation between the source cell and the candidate target cell.

In an embodiment, the computing device determines whether the source cell and a second candidate target cell included in the set of one or more candidate target cells use the same central frequency (e.g., use the same channel number) and, if so, refrains from determining coverage overlap factors for the source cell and the second candidate target cell (since carrier aggregation cannot be performed between cells using the same central frequency).

### System Overview

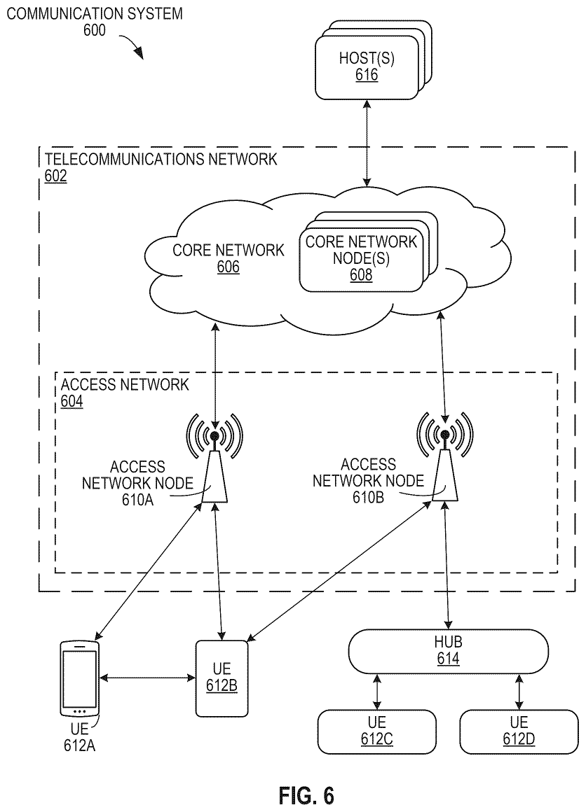

FIG. 6 is a diagram showing an example communication system 600, according to some embodiments.

In the example, the communication system 600 includes a telecommunication network 602 that includes an access network 604, such as a radio access network (RAN), and a core network 606, which includes one or more core network nodes 608. The access network 604 includes one or more access network nodes, such as network nodes 610A and 610B (one or more of which may be generally referred to as network nodes 610), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 602 includes one or more Open-RAN (ORAN) network nodes. An ORAN network node is a node in the telecommunication network 602 that supports an ORAN specification (e.g., a specification published by the O-RAN Alliance, or any similar organization) and may operate alone or together with other nodes to implement one or more functionalities of any node in the telecommunication network 602, including one or more network nodes 610 and/or core network nodes 608.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 610 facilitate direct or indirect connection of user equipment (UE), such as by connecting UEs 612A, 612B, 612C, and 612D (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more host computing systems, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 602 is a cellular network that implements 3GPP standardized features. Accordingly, the telecommunications network 602 may support network slicing to provide different logical networks to different devices that are connected to the telecommunication network 602. For example, the telecommunications network 602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 614 communicates with the access network 604 to facilitate indirect communication between one or more UEs (e.g., UE 612C and/or 612D) and network nodes (e.g., network node 610B). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a VR device, display, loudspeaker, or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular if one or more of the UEs are low energy IoT devices.

The hub 614 may have a constant/persistent or intermittent connection to the network node 610B. The hub 614 may also allow for a different communication scheme and/or schedule between the hub 614 and UEs (e.g., UE 612C and/or 612D), and between the hub 614 and the core network 606. In other examples, the hub 614 is connected to the core network 606 and/or one or more UEs via a wired connection. Moreover, the hub 614 may be configured to connect to an M2M service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610B. In other embodiments, the hub 614 may be a non-dedicated hub—that is, a device which is capable of operating to route communications between the UEs and network node 610B, but which is additionally capable of operating as a communication start and/or end point for certain data channels.

In an embodiment, the telecommunications network 602 includes a carrier aggregation configuration component (not shown) that is operable to automatically configure carrier aggregation in the telecommunications network 602, as described herein. The carrier aggregation configuration component may be implemented in the core network 606 and/or the access network 604.

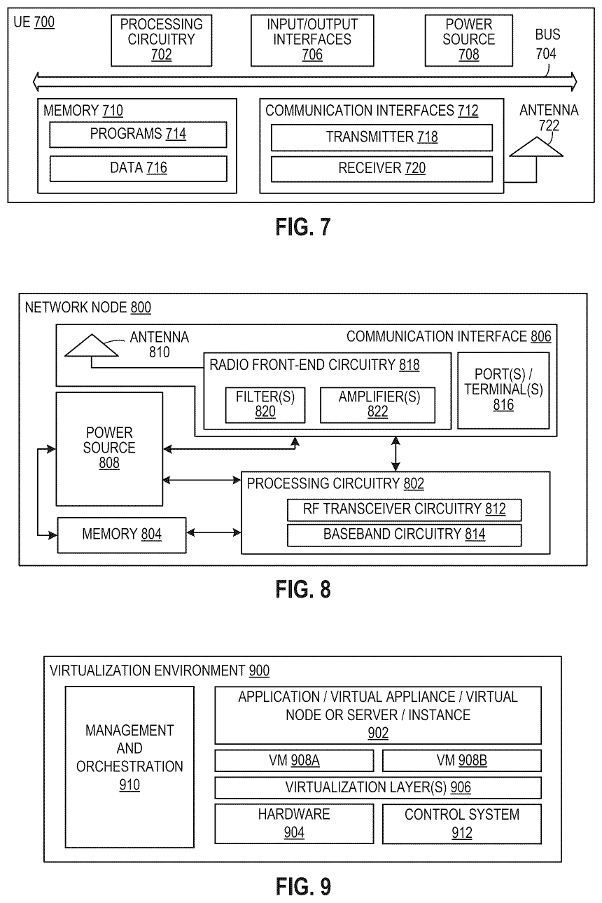

FIG. 7 is a diagram showing a UE 700, according to some embodiments. The UE 700 presents additional details of some embodiments of the UE 612 of FIG. 1. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage/playback device, wearable terminal device, wireless endpoint, mobile station, tablet, laptop, laptop-embedded equipment (LEE), laptop-mounted equipment (LME), an Augmented Reality (AR) or Virtual Reality (VR) device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, a memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 702 may include multiple central processing units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging of the power source 708. Power circuitry may perform any formatting, converting, or other modification to the power from the power source 708 to make the power suitable for the respective components of the UE 700 to which power is supplied.

The memory 710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 710 may allow the UE 700 to access instructions, application programs and the like, stored on transitory or non-transitory memory media, to off-load data, or to upload data. An article of manufacture, such as one utilizing a communication system may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., antenna 722) and may share circuit components, software or firmware, or alternatively be implemented separately.

In the illustrated embodiment, communication functions of the communication interface 712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 8 is a diagram showing a network node 800, according to some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes a processing circuitry 802, a memory 804, a communication interface 806, and a power source 808. The network node 800 may be composed of multiple physically separate components (e.g., a NodeB component and a RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 800 may be configured to support multiple radio access technologies (RATs). In such embodiments, some components may be duplicated (e.g., separate memory 804 for different RATs) and some components may be reused (e.g., a same antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 800.

The processing circuitry 802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 800 components, such as the memory 804, to provide network node 800 functionality.

In some embodiments, the processing circuitry 802 includes a system on a chip (SOC). In some embodiments, the processing circuitry 802 includes one or more of radio frequency (RF) transceiver circuitry 812 and baseband processing circuitry 814. In some embodiments, the radio frequency (RF) transceiver circuitry 812 and the baseband processing circuitry 814 may be on separate chips (or sets of chips), boards, or units, such as radio units and digital units. In alternative embodiments, part or all of RF transceiver circuitry 812 and baseband processing circuitry 814 may be on the same chip or set of chips, boards, or units.

The memory 804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and memory 804 is integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. Radio front-end circuitry 818 comprises filters 820 and amplifiers 822. The radio front-end circuitry 818 may be connected to an antenna 810 and processing circuitry 802. The radio front-end circuitry may be configured to condition signals communicated between antenna 810 and processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of filters 820 and/or amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface may comprise different components and/or different combinations of components.

In certain alternative embodiments, the network node 800 does not include separate radio front-end circuitry 818, instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes one or more ports or terminals 816, the radio front-end circuitry 818, and the RF transceiver circuitry 812, as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, communication interface 806, and/or the processing circuitry 802 may be configured to perform any receiving operations and/or certain obtaining operations described herein as being performed by the network node. Any information, data and/or signals may be received from a UE, another network node and/or any other network equipment. Similarly, the antenna 810, the communication interface 806, and/or the processing circuitry 802 may be configured to perform any transmitting operations described herein as being performed by the network node. Any information, data and/or signals may be transmitted to a UE, another network node and/or any other network equipment.

The power source 808 provides power to the various components of network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid, an electricity outlet) via an input circuitry or interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800. In some embodiments providing a core network node, such as core network node 608 of FIG. 6, some components, such as the radio front-end circuitry 818 and the RF transceiver circuitry 812 may be omitted.

FIG. 9 is a block diagram showing a virtualization environment 900 in which functionality described herein can be virtualized, according to some embodiments. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 900 includes components defined by the O-RAN Alliance, such as an O-Cloud environment orchestrated by a Service Management and Orchestration Framework via an O-2 interface. Virtualization may facilitate distributed implementations of a network node, UE, core network node, or host.

Applications 902 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908A and 908B (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g. such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 912 which may alternatively be used for communication between hardware nodes and radio units.

Although the computing devices described herein (e.g., UEs, network nodes) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments are not described with reference to any particular programming language. It will be appreciated that a variety of programming languages may be used to implement the teachings of embodiments as described herein.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

An embodiment may be an article of manufacture in which a non-transitory machine-readable storage medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

Throughout the description, embodiments have been presented through flow diagrams. It will be appreciated that the order of transactions and transactions described in these flow diagrams are only intended for illustrative purposes and not intended to be limiting. One having ordinary skill in the art would recognize that variations can be made to the flow diagrams.

In the foregoing specification, embodiments have been described with reference to specific exemplary embodiments thereof. It will be evident that various modifications may be made thereto without departing from the broader spirit and scope of the disclosure provided herein. The specification and drawings are, accordingly, to be regarded in an illustrative sense rather than a restrictive sense.

What is claimed is:

1. A method implemented in a cellular network to automatically configure inter-node carrier aggregation between cells, the method comprising:
identifying, for a source cell included in the cellular network, a set of one or more candidate target cells;
determining one or more coverage overlap factors for the source cell and a first candidate target cell included in the set of one or more candidate target cells;
determining whether carrier aggregation should be enabled between the source cell and the first candidate target cell based on the one or more coverage overlap factors; and
in response to determining that carrier aggregation should be enabled between the source cell and the first candidate target cell, enabling carrier aggregation between the source cell and the first candidate target cell.

2. The method of claim 1, wherein the source cell is a macro cell and the first candidate target cell is a small cell.

3. The method of claim 2, wherein the identifying the set of one or more candidate target cells comprises identifying one or more small cells that are neighbors of the source cell.

4. The method of claim 1, wherein the enabling carrier aggregation between the source cell and the first candidate target cell comprises adding the candidate target cell to a list of possible secondary cells for the source cell.

5. The method of claim 1, wherein the one or more coverage overlap factors include a handover factor associated with the first candidate target cell.

6. The method of claim 5, wherein the handover factor associated with the first candidate target cell is determined based on a number of handovers between the source cell and the first candidate target cell over a period of time and a number of handovers between the source cell and candidate target cells included in the set of one or more candidate target cells over the period of time.

7. The method of claim 5, wherein determining whether carrier aggregation should be enabled between the source cell and the first candidate target cell comprises determining whether the handover factor meets a threshold value.

8. The method of claim 1, wherein the one or more coverage overlap factors include a distance factor associated with the first candidate target cell.

9. The method of claim 8, wherein the distance factor associated with the first candidate target cell is determined based on a geographical distance between the source cell and the first candidate target cell and an average of geographical distances between a source node providing the source cell and neighboring nodes of the source node.

10. The method of claim 8, wherein determining whether carrier aggregation should be enabled between the source cell and the first candidate target cell comprises determining whether the distance factor meets a threshold value.

11. The method of claim 1, wherein the one or more coverage overlap factors include an azimuth correlation factor associated with the first candidate target cell.

12. The method of claim 11, wherein the azimuth correlation factor associated with the first candidate target cell is determined based on an azimuth associated with a main transmission direction of the source cell and an azimuth of a direction going from the source cell to the candidate target cell.

13. The method of claim 11, wherein determining whether carrier aggregation should be enabled between the source cell and the first candidate target cell comprises determining whether the azimuth correlation factor meets a threshold value.

14. The method of claim 1, further comprising:
before enabling carrier aggregation between the source cell and the first candidate target cell, determining whether carrier aggregation is already enabled between the source cell and the first candidate target cell, wherein the enabling carrier aggregation between the source cell and the first candidate target cell is further in response to determining that carrier aggregation is not already enabled between the source cell and the first candidate target cell.

15. The method of claim 1, further comprising:
after enabling carrier aggregation between the source cell and the first candidate target cell, determining updated one or more coverage overlap factors for the source cell and the first candidate target cell;
determining whether carrier aggregation should be enabled between the source cell and the first candidate target cell based on the updated one or more coverage overlap factors; and
in response to determining, based on the updated one or more coverage overlap factors, that carrier aggregation should not be enabled between the source cell and the first candidate target cell, disabling carrier aggregation between the source cell and the first candidate target cell.

16. The method of claim 1, further comprising:
determining second one or more coverage overlap factors for the source cell and a second candidate target cell included in the set of one or more candidate target cells;
determining whether carrier aggregation should be enabled between the source cell and the second candidate target cell based on the second one or more coverage overlap factors;
in response to determining that carrier aggregation should not be enabled between the source cell and the second candidate target cell, determining whether carrier aggregation is currently enabled between the source cell and the second candidate target cell; and
in response to determining that carrier aggregation is currently enabled between the source cell and the second candidate target cell, disabling carrier aggregation between the source cell and the second candidate target cell.

17. The method of claim 1, further comprising:
determining second one or more coverage overlap factors for the source cell and a second candidate target cell included in the set of one or more candidate target cells;
determining whether carrier aggregation should be enabled between the source cell and the second candidate target cell based on the second one or more coverage overlap factors; and
in response to determining that carrier aggregation should be enabled between the source cell and the second candidate target cell, enabling carrier aggregation between the source cell and the second candidate target cell.

18. The method of claim 17, further comprising:
assigning the source cell to be a primary cell for a user equipment (UE) in the cellular network; and
assigning the first candidate target cell and the second candidate target cell to be secondary cells for the UE.

19. The method of claim 1, further comprising:
determining whether the source cell and a second candidate target cell included in the set of one or more candidate target cells use a same central frequency; and
in response to determining that the source cell and a second candidate target cell use the same central frequency, refraining from determining coverage overlap factors for the source cell and the second candidate target cell.

20. A non-transitory machine-readable medium storing instructions that, when executed by at least one processor, cause the at least one processor to perform operations for automatically configuring inter-node carrier aggregation between cells in a cellular network, the operations comprising:
identifying, for a source cell included in the cellular network, a set of one or more candidate target cells;
determining one or more coverage overlap factors for the source cell and a first candidate target cell included in the set of one or more candidate target cells;
determining whether carrier aggregation should be enabled between the source cell and the first candidate target cell based on the one or more coverage overlap factors; and
in response to determining that carrier aggregation should be enabled between the source cell and the first candidate target cell, enabling carrier aggregation between the source cell and the first candidate target cell.

21. The non-transitory machine-readable medium of claim 20, wherein the one or more coverage overlap factors include a handover factor associated with the first candidate target cell, a distance factor associated with the first candidate target cell, and an azimuth correlation factor associated with the first candidate target cell.
